(19) United States
(12) Patent Application Publication
(10) Pub. No.: US 2024/0416489 A1
(43) Pub. Date: Dec. 19, 2024

(54) SOCKET FOR POWER TOOL, METHODS OF CONTROLLING POWER TOOLS, CONTROL SYSTEMS AND POWER TOOLS

(71) Applicant: ATLAS COPCO INDUSTRIAL TECHNIQUE AB, Stockholm (SE)

(72) Inventor: Jakob LINDSTRÖM, Enskede (SE)

(73) Assignee: ATLAS COPCO INDUSTRIAL TECHNIQUE AB, Stockholm (SE)

(21) Appl. No.: 18/713,844

(22) PCT Filed: Nov. 1, 2022
(86) PCT No.: PCT/EP2022/080438

§ 371 Date: May 28, 2024

(30) Foreign Application Priority Data
Dec. 8, 2021 (SE) 2130347-4

(51) Int. Cl. B25B 23/00

(52) U.S. Cl. CPC B25B 21/002; B25B 23/0035

(57) ABSTRACT

A socket for a power tool, the socket being arranged to rotate about a socket axis and comprises a cylindrical section having an end surface, a plurality of engaging surfaces parallel with the socket axis on an internal side of the cylindrical section; an inner section positioned radially inside the cylindrical section with respect to the socket axis and having a stopping surface offset from the end surface such that the engaging surfaces are positioned between the stopping surface and the end surface; and a socket opening extending radially with respect to the socket axis through the cylindrical section and the inner section; wherein the cylindrical section comprises at least one internal slope on the internal side of the cylindrical section extending away from the stopping surface. Methods, control systems and power tools are also provided.

### TECHNICAL FIELD

The present disclosure generally relates to power tools. In particular, a socket for a power tool comprising at least one internal slope, a method of controlling a power tool comprising such a socket, a control system for controlling a power tool comprising such a socket, a method of controlling a power tool comprising a checking operation, a control system for controlling a power tool to perform the checking operation, and power tools, are provided.

### BACKGROUND

An open end power tool may comprise a socket rotatable about a socket axis and having a socket opening for receiving a bolt or a shaft in a radial direction with respect to the socket axis. For example, if a bolt enclosing a shaft is to be threaded onto a coupling on the shaft, the socket is positioned in an open position and the power tool is moved relative to the shaft such that the shaft is received radially through the socket opening. The power tool and/or the bolt may then be moved axially along the shaft such that the bolt is received in the socket. The power tool can then be used to tighten the bolt to the coupling.

With some prior art power tools, the operator must perform the following steps after each tightening operation: release an actuating element, lift the power tool from the bolt, press and hold the actuating element again to control the socket to move back to the open position, and remove the power tool from the shaft. In such power tools, the socket may be rotated in alternating directions each time the actuating element is actuated.

### SUMMARY

One object of the present disclosure is to provide an improved socket for a power tool.

A further object of the present disclosure is to provide a socket for a power tool, which socket enables a faster positioning of the socket in an open position.

A still further object of the present disclosure is to provide a socket for a power tool, which socket enables an easier removal of the power tool after tightening a joint.

A still further object of the present disclosure is to provide a socket for a power tool, which socket solves several or all of the foregoing objects in combination.

A still further object of the present disclosure is to provide a method of controlling a power tool, which method solves one, several or all of the foregoing objects.

A still further object of the present disclosure is to provide a control system for controlling a power tool, which control system solves one, several or all of the foregoing objects.

A still further object of the present disclosure is to provide a power tool solving one, several or all of the foregoing objects.

According to a first aspect, there is provided a socket for a power tool, the socket being arranged to rotate about a socket axis and comprises a cylindrical section having an end surface, a plurality of engaging surfaces parallel with the socket axis on an internal side of the cylindrical section; an inner section positioned radially inside the cylindrical section with respect to the socket axis and having a stopping surface offset from the end surface such that the engaging surfaces are positioned between the stopping surface and the end surface; and a socket opening extending radially with respect to the socket axis through the cylindrical section and the inner section; wherein the cylindrical section comprises at least one internal slope on the internal side of the cylindrical section extending away from the stopping surface.

Due to comprising the socket opening, the socket is an open end socket. The power tool comprising the socket may be referred to as an open end power tool.

During a tightening operation of a joint, the engaging surfaces may engage engageable surfaces of a bolt and the socket may be rotated in a tightening direction. When the tightening operation is completed, the socket may be rotated in a releasing direction, opposite to the tightening direction. The socket may for example automatically be rotated in the releasing direction immediately after completion of the tightening operation. When the socket rotates in the releasing direction, each internal slope engages a corner between engageable surfaces on the bolt. This causes the socket to move along the socket axis away from the bolt while the corner travels along the internal slope until the socket slips off the bolt. The socket can thus rapidly and easily be separated from a tightened joint by rotating the socket in the releasing direction.

When the socket is separated from the joint, the socket may continue to rotate in the releasing direction to an open position where the socket opening is aligned with a base opening of a base element. The socket can thereby rapidly and easily be positioned in the open position. The socket enables an automatic positioning of the socket in the open position immediately after a completed tightening operation. The operator does therefore not have to lift the power tool off the bolt and run a separate positioning program for positioning the socket in the open position.

The socket may be configured to tighten a bolt in a conventional way by rotation in the tightening direction. The power tool may be of any type as described herein when comprising the socket having at least one internal slope.

Due to the socket opening, the cylindrical section does not fully enclose the socket axis. The socket opening may extend through the entire socket in a direction parallel with the socket axis.

The engaging surfaces may be positioned between the stopping surface and the end surface along a direction parallel with the socket axis. The engaging surfaces may be configured to engage engageable surfaces on a bolt to be tightened. The cylindrical section may for example comprise at least four engaging surfaces, such as six engaging surfaces.

The internal side is a side facing the socket axis. The at least one internal slope may be positioned between the end surface and the stopping surface as seen in a plane transverse to the socket axis. Each internal slope may extend from the stopping surface. Each of the end surface and the stopping surface may be flat and perpendicular to the socket axis.

The at least one internal slope may comprise a plurality of internal slopes. One internal slope may be associated with each of at least four engaging surfaces. The socket may thus comprise at least four internal slopes.

Each internal slope may be straight. Alternatively, or in addition, each internal slope may extend from the stopping surface to the end surface.

The cylindrical section may comprise a circular drive profile concentric with the socket axis on an external side of the cylindrical section for being drivingly engaged by a wheel. The external side is a side facing away from the socket axis. The drive profile may comprise teeth or a friction surface.

According to a second aspect, there is provided a method of controlling a power tool for tightening a joint, the power tool comprising a base element having a base opening, a socket according to the first aspect, a motor arranged to drive the socket, and a control system configured to control the motor, where the socket is rotatable about the socket axis from an open position where the socket opening is aligned with the base opening, the method comprising commanding, by the control system, performance of a tightening operation by the socket for tightening the joint; and commanding, by the control system, performance of a releasing operation by the socket, after performing the tightening operation.

The releasing operation may be performed automatically immediately after completion of the tightening operation. Thus, instead of performing the releasing operation as a separate job, e.g. in response to a command from the operator, the method may start the releasing operation immediately after completion of the tightening operation. Alternatively, the releasing operation may be initiated by the operator, for example by actuating an actuating element of the power tool.

During the tightening operation, the socket is rotated about the socket axis in a tightening direction. The tightening operation may be considered completed when a target torque has been applied to the joint. The releasing operation May comprise rotating the socket about the socket axis in a releasing direction, opposite to the tightening direction.

According to a third aspect, there is provided a control system for controlling a power tool for tightening a joint, the power tool comprising a base element having a base opening, a socket according to the first aspect, a motor arranged to drive the socket, and a control system configured to control the motor, where the socket is rotatable about the socket axis from an open position where the socket opening is aligned with the base opening, the control system comprising at least one data processing device and at least one memory having at least one computer program stored thereon, the at least one computer program comprising program code which, when executed by the at least one data processing device, causes the at least one data processing device to perform the steps of commanding performance of a tightening operation by the socket for tightening the joint; and commanding performance of a releasing operation by the socket, after performing the tightening operation.

According to a fourth aspect, there is provided a method of controlling a power tool for tightening a joint, the power tool comprising a base element having a base opening, a socket having a socket opening, a motor arranged to drive the socket, and a control system configured to control the motor, where the socket is rotatable about a socket axis from an open position where the socket opening is aligned with the base opening, the method comprising commanding, by the control system, performance of a tightening operation by the socket for tightening the joint; commanding, by the control system, performance of a checking operation by the socket, after performing the tightening operation; monitoring, by the control system, a response to the checking operation of at least one parameter associated with the socket; determining, by the control system, based on the response whether the socket is engaged with the joint; and commanding, by the control system, positioning of the socket in the open position upon determining that the socket is not engaged with the joint.

The checking operation may be performed automatically immediately after completion of the tightening operation. As soon as it is determined that the socket is no longer engaged with the joint, the socket may automatically be positioned in the open position. Thus, instead of lifting the power tool off the joint and then manually commanding the socket to move to the open position, the operator may simply move the power tool away from the joint. The method then automatically concludes that the socket is free from the bolt and automatically rotates the socket to the open position. The rotational speed of the socket may be increased upon determining that the socket is not engaged with the joint.

By evaluating the response to the checking operation, it can automatically be sensed when the socket is separated from the joint. The method thus enables the tightening operation and a positioning of the socket in the open position to be performed in a single sequence. The method enables the socket to be automatically returned to the open position after the tightening operation. In some applications, the method enables a time saving of around a second for each tightening cycle.

The determination of whether or not the socket is engaged with the joint can be done in various ways. According to one example, it is concluded that the socket rotates freely when the socket has rotated more than a threshold angular distance about the socket axis, such as 20 degrees to 30 degrees.

The checking operation may comprise rotating the socket, or commanding the socket to rotate, in either a tightening direction or in a releasing direction about the socket axis. The socket should however only exert relatively small torques such that a tightening torque in the joint accomplished by the tightening operation is not changed if the socket is not separated from the joint. That is, the checking operation should not cause the joint to be further tightened or loosened.

The power tool may comprise a socket according to the first aspect. In this case, the checking operation may comprise a releasing operation according to the second or third aspects. The releasing operation can be used to both cause separation of the power tool from the joint and to determine when this separation has occurred. Alternatively, the power tool may comprise a socket not comprising internal slopes.

The checking operation may comprise controlling the socket based on a rotational position, a rotational speed, a rotational acceleration, a torque and/or a current.

The checking operation may comprise controlling the socket based on a torque that is smaller than a maximum torque during the tightening operation. The maximum torque during the checking operation may be less than 30%, such as less than 20%, of the maximum torque during the tightening operation.

The checking operation may comprise controlling the socket based on a current that is smaller than a maximum current during the tightening operation.

The socket may be commanded to perform the checking operation in pulses. The socket may be controlled based on a relatively large torque during the pulses and based on a relatively small, zero or negative torque between the pulses. Alternatively, or in addition, the socket may be controlled based on a relatively large current during the pulses and based on a relatively small, zero or negative current between the pulses. In any case, the pulses may have a frequency of at least 5 Hz, such as 10 Hz.

As an alternative to pulses, the checking operation may comprise controlling the socket based on a constant torque. The constant torque may then be set small enough such that the power tool can be separated from the joint. When the power tool is separated from the joint, the constant torque will cause the socket to start rotating. Based on this rotation, it can be concluded that the power tool has been separated from the joint.

The at least one parameter may comprise a rotational position, a rotational speed, a rotational acceleration, a torque and/or a current.

The method may further comprise determining whether the tightening operation was successful, and commanding performance of the checking operation upon determining that the tightening operation was successful. In case the tightening operation was not successful, a warning may be issued to the operator. The socket may be prevented from returning to the open position if the tightening operation was not successful.

The power tool may comprise an actuating element for being actuated by a human operator. In this case, the method may comprise commanding performance of the tightening operation and the checking operation regardless of whether the actuating element is actuated. Upon completion of the tightening operation, the operator may simply move the power tool away from the joint without releasing the actuating element. Once the socket is free from the joint, the socket is automatically brought back to the open position.

According to a fifth aspect, there is provided a control system for controlling a power tool for tightening a joint, the power tool comprising a base element having a base opening, a socket having a socket opening, a motor arranged to drive the socket, and a control system configured to control the motor, where the socket is rotatable about a socket axis from an open position where the socket opening is aligned with the base opening, the control system comprising at least one data processing device and at least one memory having at least one computer program stored thereon, the at least one computer program comprising program code which, when executed by the at least one data processing device, causes the at least one data processing device to perform the steps of commanding performance of a tightening operation by the socket; commanding performance of a checking operation by the socket, after performing the tightening operation; monitoring a response to the checking operation of at least one parameter associated with the socket; determining based on the response whether the socket can rotate freely; and commanding positioning of the socket in the open position upon determining that the socket can rotate freely.

The at least one computer program may comprise program code which, when executed by the at least one data processing device, causes the at least one data processing device to perform any of the steps according to the fourth aspect.

According to a sixth aspect, there is provided a power tool comprising the socket according to the first aspect, the control system according to the third aspect and/or the control system according to the fifth aspect. The power tool may be used to deliver torque to a joint. The power tool may be handheld.

### BRIEF DESCRIPTION OF THE DRAWINGS

Further details, advantages and aspects of the present disclosure will become apparent from the following description taken in conjunction with the drawings, wherein:

FIG. 1a: schematically represents a side view of a power tool;

FIG. 1b: schematically represents a top view of the power tool;

FIG. 2: schematically represents a partially cross-sectional side view of the power tool when a tool head is detached from a main body;

FIG. 3a: schematically represents a cross-sectional side view of the tool head;

FIG. 3b: schematically represents a top view of components of the tool head;

FIG. 4: schematically represents a perspective view of a socket of the power tool;

FIG. 5a: schematically represents a top view of the socket comprising a positioning device;

FIG. 5b: schematically represents a top view of the socket comprising a further example of a positioning device;

FIG. 6a: schematically represents a side view of an unassembled joint comprising a coupling and a bolt;

FIG. 6b: schematically represents a side view of the joint when the bolt is assembled to the coupling using the power tool;

FIG. 6c: schematically represents a side view of the joint when the power tool is removed from the joint;

FIG. 7a: schematically represents a diagram showing current to a motor during a checking operation as a function of time;

FIG. 7b: schematically represents a diagram showing rotational position during the checking operation as a function of time;

FIG. 7c: schematically represents a diagram showing rotational speed during the checking operation as a function of time;

FIG. 7d: schematically represents a diagram showing rotational acceleration during the checking operation as a function of time;

FIG. 7e: schematically represents a diagram showing torque during the checking operation as a function of time;

FIG. 8a: schematically represents a perspective view of a further example of a socket for the power tool;

FIG. 8b: schematically represents a side view of the socket in FIG. 8a;

FIG. 8c: schematically represents a top view of the socket in FIGS. 8a and 8b;

FIG. 9a: schematically represents a top view of the socket in FIGS. 8a to 8c receiving the joint;

FIG. 9b: schematically represents a top view of the socket and the joint in FIG. 9a when the socket is rotated in a tightening direction;

FIG. 9c: schematically represents a top view of the socket and the joint in FIG. 9a when the socket is rotated in a releasing direction;

FIG. 10a: schematically represents a side view of the socket and the joint in FIG. 9a; and

FIG. 10b: schematically represents a side view of the socket and the joint in FIG. 9c when the socket is rotated in the releasing direction.

### DETAILED DESCRIPTION

In the following, a socket for a power tool comprising at least one internal slope, a method of controlling a power tool comprising such socket, a control system for controlling a power tool comprising such socket, a method of controlling a power tool comprising a checking operation, a control system for controlling a power tool to perform the checking operation, and power tools, will be described. The same or similar reference numerals will be used to denote the same or similar structural features.

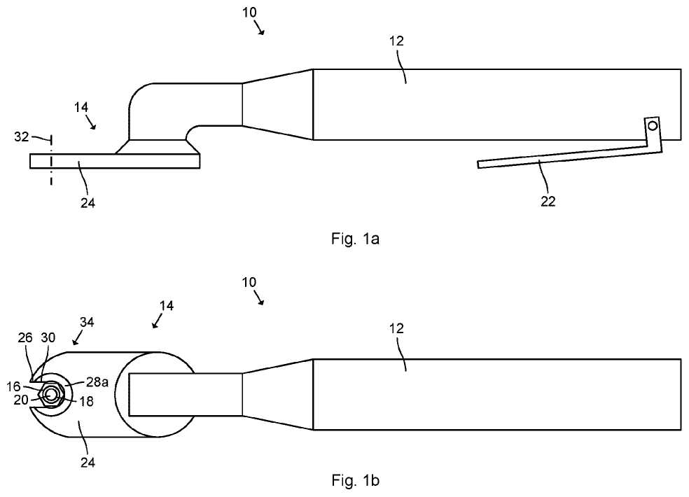

FIG. 1a schematically represents a side view of a power tool 10, and FIG. 1b schematically represents a top view of the power tool 10. With collective reference to FIGS. 1a and 1b, the power tool 10 comprises a main body 12 and a tool head 14. The tool head 14 is detachably attached to the main body 12 in this example. The main body 12 is here exemplified as a housing.

The power tool 10 of this example is a handheld open end power tool for tightening. The power tool 10 may for example be driven electrically. As shown in FIG. 1b, the power tool 10 can for example be used to tighten a bolt 16 on a threaded coupling 18. The coupling 18 may in turn enclose a pipe 20.

The power tool 10 of this example further comprises an actuating element 22. The actuating element 22 is here exemplified as a lever rotatable relative to the main body 12 by manual actuation.

The tool head 14 comprises a base element 24. The base element 24 comprises a base opening 26 at a distal end thereof.

The tool head 14 further comprises a socket 28a having a socket opening 30. Thus, the socket 28a is an open end socket and the power tool 10 is an open end power tool. The socket 28a is rotatable relative to the base element 24 about a socket axis 32. In FIGS. 1a and 1b, the socket 28a is in an open position 34. In the open position 34, the socket opening 30 is aligned with the base opening 26 and can thereby receive the pipe 20 in a radial direction with respect to the socket axis 32. The power tool 10 may then be moved axially along the pipe 20 to axially receive the bolt 16 in the socket opening 30.

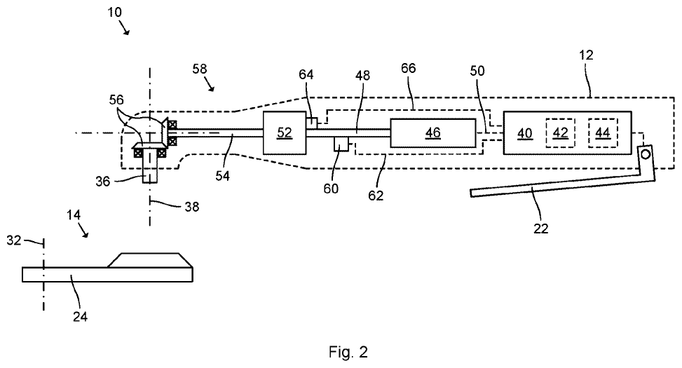

FIG. 2 schematically represents a partially cross-sectional side view of the power tool 10. The tool head 14 is here detached from the main body 12. As shown in FIG. 2, the main body 12 of this example comprises a drive shaft 36. The drive shaft 36 is rotatable about a drive axis 38. In this example, the drive axis 38 is parallel with the socket axis 32 when the tool head 14 is attached to the main body 12.

The power tool 10 of this example further comprises a control system 40. The control system 40 is here provided in the main body 12. The control system 40 comprises a data processing device 42 and a memory 44. The memory 44 has a computer program stored thereon. The computer program comprises program code which, when executed by the data processing device 42, causes the data processing device 42 to perform, or command performance of, various steps as described herein.

The power tool 10 of this example further comprises an electric motor 46 housed within the main body 12. The motor 46 rotationally drives a motor shaft 48. The control system 40 is in signal communication with the motor 46 and controls operation of the motor 46, here by sending a current 50 to the motor 46.

The power tool 10 of this example further comprises a reduction gear 52 and an intermediate shaft 54. The reduction gear 52 is configured to transmit a rotation of the motor shaft 48 at a first rotational speed to a rotation of the intermediate shaft 54 at a second rotational speed, lower than the first rotational speed. A rotation of the intermediate shaft 54 is transmitted to a rotation of the drive shaft 36 via bevel gears 56. In this way, the power tool 10 is configured to transmit a rotation of the motor shaft 48 to a rotation of the drive shaft 36. The reduction gear 52, the intermediate shaft 54 and the bevel gears 56 constitute one of many examples of a motor transmission 58 configured to transmit a rotation of the motor 46 to a rotation of the drive shaft 36.

The power tool 10 further comprises a position sensor 60. The position sensor 60 is arranged to measure a position, here a rotational position 62, of the motor shaft 48.

The power tool 10 further comprises a torque sensor 64. The torque sensor 64 is arranged to measure a torque 66, here exemplified as an input torque to the reduction gear 52.

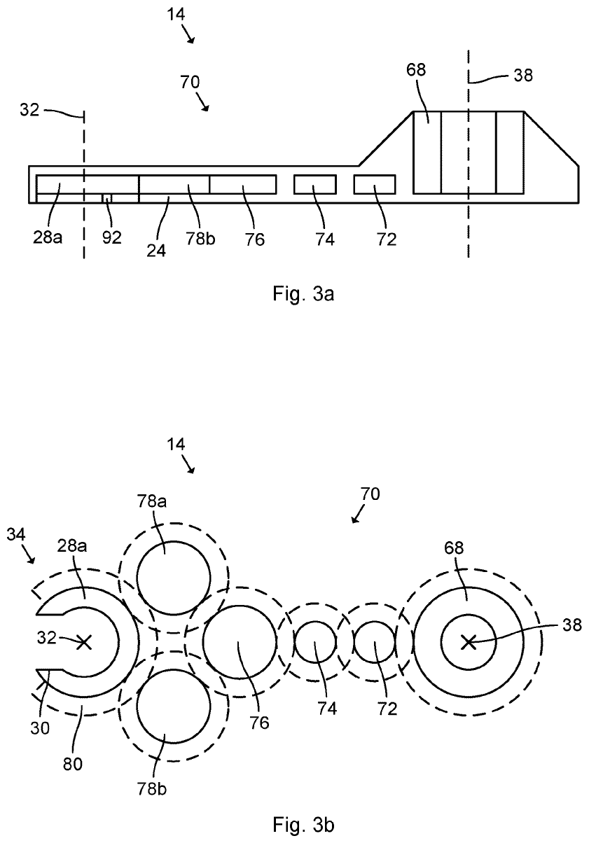

FIG. 3a schematically represents a cross-sectional side view of the tool head 14, and FIG. 3b schematically represents a top view of components of the tool head 14. With collective reference to FIGS. 3a and 3b, the tool head 14 of this example comprises a drive member 68. The drive member 68 is rotatable about the drive axis 38 relative to the base element 24. The drive member 68 is here exemplified as a hollow shaft arranged to receive the drive shaft 36 for being driven thereby.

The tool head 14 further comprises a drive transmission 70. The drive transmission 70 is configured to transmit a rotation of the drive member 68 about the drive axis 38 to a rotation of the socket 28a about the socket axis 32. In this example, the ratio between the drive member 68 and the socket 28a is 1:1. The drive transmission 70 of this specific example comprises a first gear wheel 72 in meshing engagement with a toothed portion of the drive member 68, a second gear wheel 74 in meshing engagement with the first gear wheel 72, a third gear wheel 76 in meshing engagement with the second gear wheel 74, a primary fourth gear wheel 78a in meshing engagement with each of the third gear wheel 76 and a toothed drive profile 80 of the socket 28a, and a secondary fourth gear wheel 78b in meshing engagement with each of the third gear wheel 76 and the drive profile 80 of the socket 28a. The drive profile 80 is thus drivingly engaged by the fourth gear wheels 78a and 78b. By means of the motor transmission 58 and the drive transmission 70, the power tool 10 is configured to transmit a rotation of the motor shaft 48 to a rotation of the socket 28a.

Based on the rotational position of the motor shaft 48, the rotational position of the socket 28a can be determined. Furthermore, based on the torque 66 at the reduction gear 52, the torque on the socket 28a can be determined.

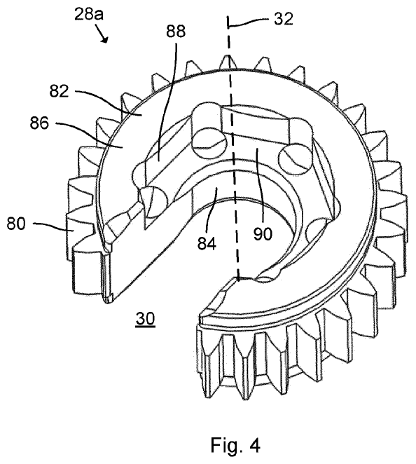

FIG. 4 schematically represents a perspective view of the socket 28a. The socket 28a comprises a cylindrical section 82 and an inner section 84. The inner section 84 is positioned radially inside the cylindrical section 82 with respect to the socket axis 32. As shown, the drive profile 80 is provided on an external side of the cylindrical section 82.

The cylindrical section 82 comprises an end surface 86 and a plurality of engaging surfaces 88. Each engaging surface 88 is provided on an internal side of the cylindrical section 82. Moreover, each engaging surface 88 is parallel with the socket axis 32. In this example, the cylindrical section 82 comprises four full-sized engaging surfaces 88 and two smaller engaging surfaces 88 that are limited by the socket opening 30. As shown in FIG. 4, the socket opening 30 extends radially through the cylindrical section 82 and the inner section 84 with respect to the socket axis 32.

The inner section 84 comprises a stopping surface 90. The stopping surface 90 and the end surface 86 are offset from each other in a direction parallel with the socket axis 32. In this example, each of the end surface 86 and the stopping surface 90 is flat and perpendicular to the socket axis 32. In FIG. 4, the stopping surface 90 is positioned below the end surface 86. The engaging surfaces 88 are positioned between the end surface 86 and the stopping surface 90 along a direction parallel with the socket axis 32.

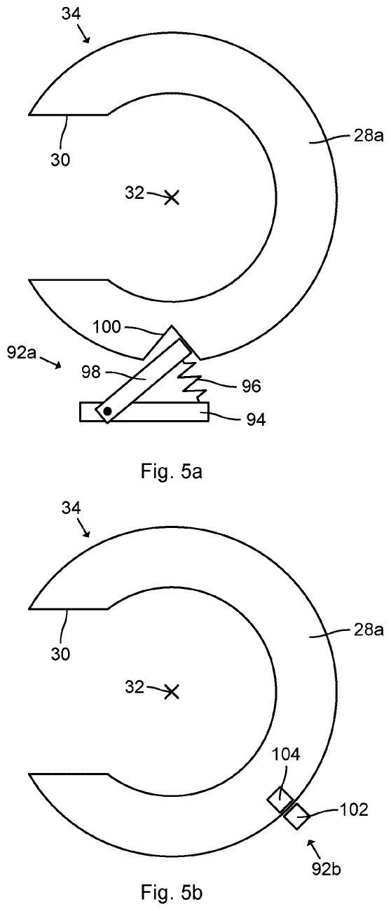

FIG. 5a schematically represents a top view of the socket 28a. The socket 28a of this example comprises a positioning device 92a. The positioning device 92a of this example comprises a positioning base 94, a spring 96 and a stopper 98. The positioning device 92a further comprises a recess 100 in the socket 28a, such as in the cylindrical section 82 offset from the drive profile 80. The positioning base 94 may be fixed to the base element 24.

When the socket 28a is rotated in a counterclockwise direction as seen in FIG. 5a, the recess 100 can pass by the stopper 98. The socket 28a in FIG. 5a can therefore rotate endlessly in the counterclockwise direction. When the socket 28a is rotated in the clockwise direction in FIG. 5a and the recess 100 reaches the stopper 98, the spring 96 will push the stopper 98 into the recess 100 and the socket 28a will be stopped in the open position 34.

FIG. 5b schematically represents a top view of the socket 28a. The socket 28a comprises a further example of a positioning device 92b. The positioning device 92b may be positioned on the cylindrical section 82 offset from the drive profile 80 in a direction parallel with the socket axis 32.

The positioning device 92b of this example is a sensor comprising an active part 102 and a passive part 104. In this example, the active part 102 is a Hall effect sensor fixed to the base element 24 and the passive part 104 is a magnet fixed to the socket 28a, such as to the cylindrical section 82 offset from the drive profile 80. The active part 102 is in signal communication with the control system 40. When the socket 28a is in the open position 34, the active part 102 detects proximity of the passive part 104.

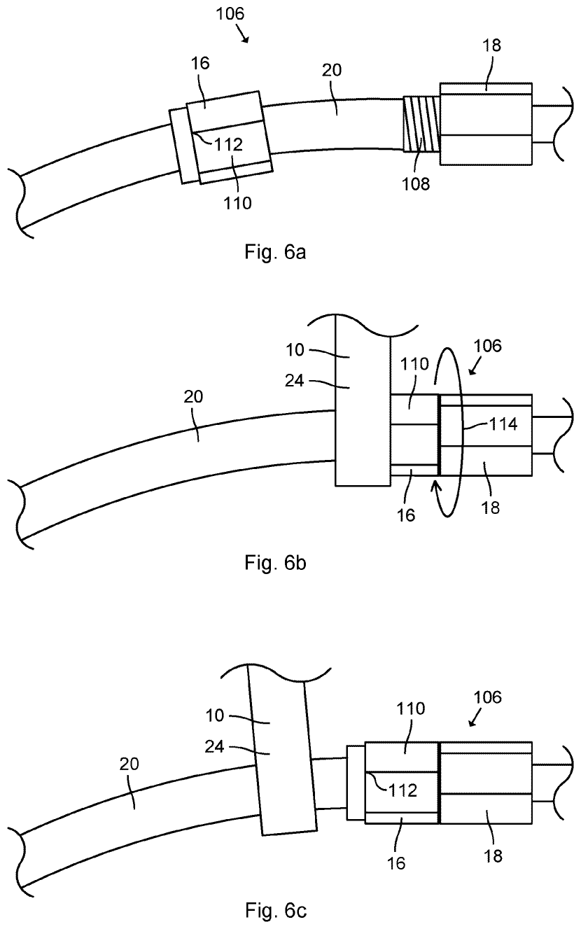

FIG. 6a schematically represents a side view of an unassembled joint 106. The joint 106 of this specific example comprises the pipe 20, the coupling 18 and the bolt 16 as already shown in FIG. 1b. The coupling 18 comprises an external thread 108. In FIG. 6a, the bolt 16 encloses the pipe 20 but does not threadingly engage the external thread 108.

The bolt 16 of this example comprises six engageable surfaces 110 and twelve corners 112 between the engageable surfaces 110. Six corners 112 are positioned at one end (the left end in FIG. 6a) of the bolt 16 and six corners 112 are positioned at an opposite end (the right end in FIG. 6a).

When the socket 28a is positioned in the open position 34, the power tool 10 can be moved to receive the pipe 20 through the socket opening 30 in a radial direction with respect to the socket axis 32. The power tool 10 can then be moved axially along the pipe 20 to receive the bolt 16 in the socket 28a. When the bolt 16 is received in the socket 28a, each engaging surface 88 is parallel with an associated engageable surface 110 of the bolt 16. Moreover, the power tool 10 can be moved axially (to the right in FIG. 6a) relative to the bolt 16 until the bolt 16 abuts the stopping surface 90 inside the socket 28a.

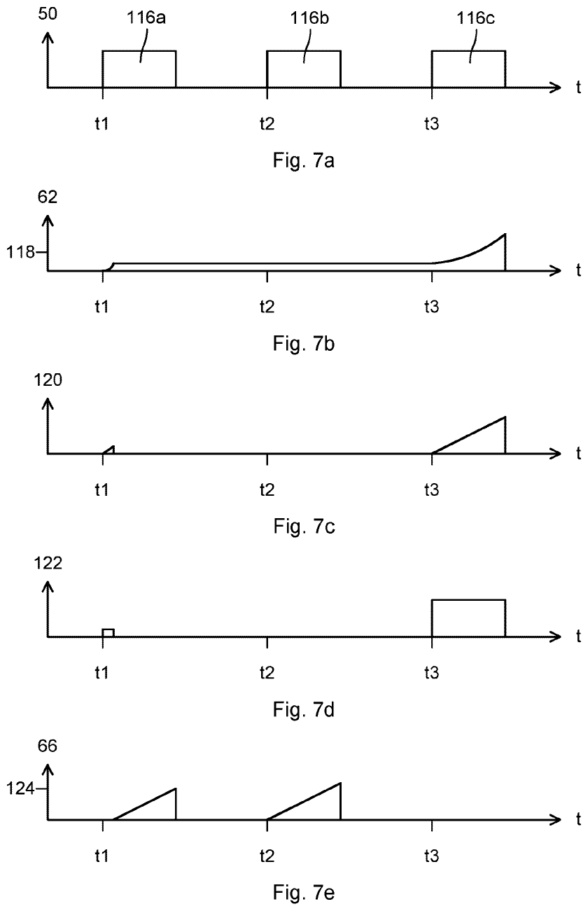

FIG. 6b schematically represents a side view of the joint 106 when the bolt 16 is assembled to the coupling 18 using the power tool 10. A tightening operation of the joint 106 is now performed. In this example, the control system 40 commands the motor 46 to perform the tightening operation in response to actuation of the actuating element 22. During the tightening operation, the socket 28a rotates the bolt 16 in a tightening direction 114 to tighten the joint 106. During the tightening operation, the socket 28a is initially controlled with a constant rotational speed until a torque threshold is reached. The rotational speed may then be reduced until a target torque in the joint 106 is reached. A green light may be displayed when the tightening operation is successful. A red light may be displayed should the tightening operation not be successful. Immediately when the tightening operation is completed, the control system 40 commands performance of a checking operation, for example as described in FIGS. 7a to 7e. The checking operation may be made conditional upon a successful tightening operation.

FIG. 6c schematically represents a side view of the joint 106 when the power tool 10 is removed from the joint 106. The operator may remove the power tool 10 from the joint 106 immediately after completion of the tightening operation. The removal of the power tool 10 from the joint 106 can be detected by the checking operation.

FIG. 7a schematically represents a diagram showing the current 50 to the motor 46 during the checking operation as a function of time t. As shown, the control system 40 sends pulses 116a-116c of current 50 to the motor 46 during the checking operation. The current 50 is one example of a parameter associated with the socket 28a. A first pulse 116a is sent at a time t1, a second pulse 116b is sent at a time t2, and a third pulse 116c is sent at a time t3. Between the pulses 116a-116c, the current 50 is zero in this example. The time step between the pulses 116a-116c may for example be 0.1 s. At times t1 and t2, the socket 28a is engaged with the bolt 16. At time t3, the socket 28a is separated from the bolt 16.

In this example, each pulse 116a-116c is positive to command the socket 28a to rotate in a releasing direction, opposite to the tightening direction 114. The pulses 116a-116c may however be negative to command the socket 28a to rotate in the tightening direction 114, or alternatingly commanding rotation in the releasing direction and the tightening direction 114.

FIG. 7b schematically represents a diagram showing the rotational position 62 during the checking operation as a function of time t. There is a linear relationship between the rotational position 62 as measured by the position sensor 60 and the rotational position of the socket 28a. The position 62 is thus a further example of a parameter associated with the socket 28a. The control system 40 monitors a response of the rotational position 62 to the pulses 116a-116c.

At time t1, the socket 28a rotates slightly from a starting position within a play between the engaging surfaces 88 of the socket 28a and the engageable surfaces 110 of the bolt 16. The socket 28a then stops shortly after time t1. The control system 40 can thereby conclude that the socket 28a is engaged with the joint 106.

At time t2, there is no change in rotational position 62. The control system 40 can thereby conclude that the socket 28a is still engaged with the joint 106.

At time t3, the socket 28a rotates past a threshold angular distance 118. Based on this, the control system 40 can conclude that the socket 28a is now not engaged with the joint 106. The threshold angular distance 118 may for example be 20 degrees to 30 degrees.

FIG. 7c schematically represents a diagram showing a rotational speed 120 of the socket 28a during the checking operation as a function of time t. The control system 40 determines the rotational speed 120 based on the measured rotational positions 62. There is a linear relationship between the rotational speed 120 determined based on the rotational position 62 and the rotational speed of the socket 28a. The rotational speed 120 is thus a further example of a parameter associated with the socket 28a. The control system 40 monitors a response of the rotational speed 120 to the pulses 116a-116c. At time t1, the rotational speed 120 increases slightly for a short time period. At time t2, the rotational speed 120 is zero. At time t3, the rotational speed 120 increases more indicating that the socket 28a is free from the bolt 16.

FIG. 7d schematically represents a diagram showing a rotational acceleration 122 of the socket 28a during the checking operation as a function of time t. The control system 40 determines the rotational acceleration 122 based on the measured rotational positions 62. There is a linear relationship between the rotational acceleration 122 and the rotational acceleration of the socket 28a. The rotational acceleration 122 is thus a further example of a parameter associated with the socket 28a. The control system 40 monitors a response of the rotational acceleration 122 to the pulses 116a-116c. At time t1, there is a small rotational acceleration 122 for a short time period. At time t2, the rotational acceleration 122 is zero. At time t3, the rotational acceleration 122 increases indicating that the socket 28a is free from the bolt 16.

FIG. 7e schematically represents a diagram showing a torque 66 of the socket 28a during the checking operation as a function of time t. The torque on the socket 28a can be determined based on the torque 66 as measured by the torque sensor 64. The torque 66 is thus a further example of a parameter associated with the socket 28a. The control system 40 monitors a response of the torque 66 to the pulses 116a-116c. Shortly after time t1, the torque 66 increases until reaching a torque threshold 124. The torque threshold 124 is substantially lower than a tightening torque and may for example be 1 Nm.

When the torque 66 reaches the torque threshold 124, the pulse 116a stops. At time t2, the torque 66 again increases until reaching the torque threshold 124 and the pulse 116b stops. At time t3 however, there is no increase of the torque 66. After time t3, the socket 28a rotates more than the threshold angular distance 118 from the starting position without the torque 66 reaching the torque threshold 124. This inter alia indicates that the power tool 10 has been separated from the joint 106.

In this specific example, each pulse 116a-116c stops when the torque 66 reaches the torque threshold 124 and the socket 28a then remains in this position until the next pulse 116a-116c. Optionally, the socket 28a may be returned to the starting position after each pulse 116a-116c.

Immediately when the control system 40 has determined that the socket 28a is not engaged with the joint 106, the control system 40 automatically commands positioning of the socket 28a in the open position 34, in this example regardless of how or if the actuating element 22 is actuated. The rotational speed 120 can be increased when positioning the socket 28a in the open position 34 upon concluding that the power tool 10 is free from the joint 106. The operator can therefore simply remove the power tool 10 from the joint 106 and from the pipe 20 upon completion of the tightening operation. The power tool 10 will automatically take care of positioning the socket 28a in the open position 34 without needing a further command to this end from the operator. This enables significant time savings.

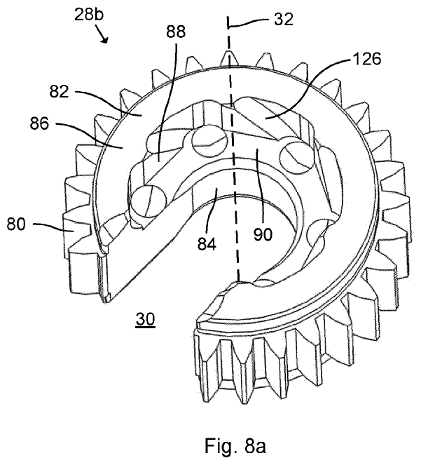

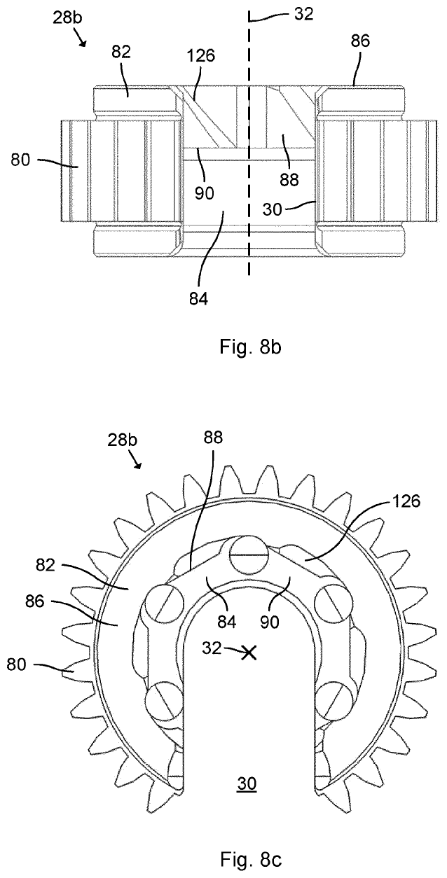

FIG. 8a schematically represents a perspective view of a further example of a socket 28b for the power tool 10. FIG. 8b schematically represents a side view of the socket 28b, and FIG. 8c schematically represents a top view of the socket 28b. With collective reference to FIGS. 8a to 8c, the socket 28b differs from the socket 28a by additionally comprising internal slopes 126. The socket 28b of this example comprises four internal slopes 126. The internal slopes 126 are positioned on the internal side of the cylindrical section 82. Each internal slope 126 is here formed by a cutout in a respective engaging surface 88. As shown, each internal slope 126 of this example is straight and extends from the stopping surface 90 to the end surface 86. As particularly shown in FIG. 8c, each internal slope 126 is positioned between the end surface 86 and the stopping surface 90 as seen in a plane transverse to the socket axis 32.

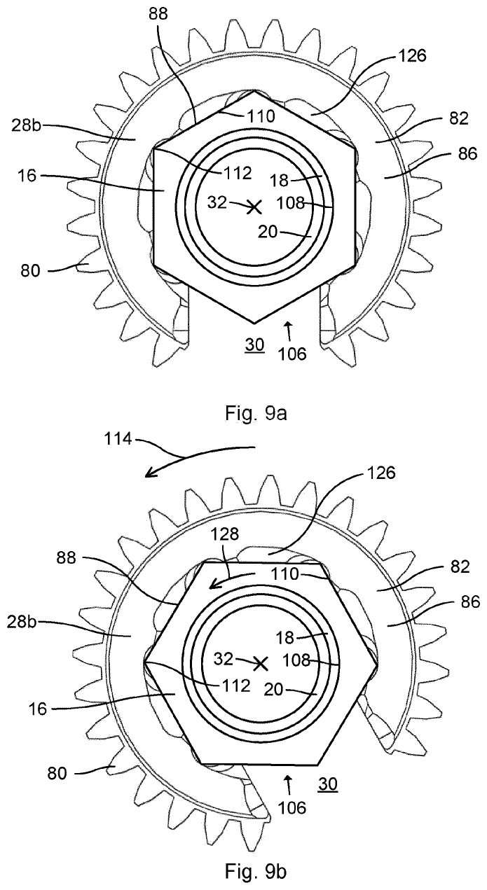

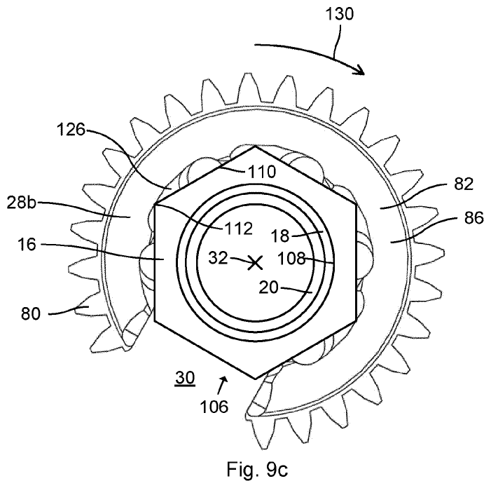

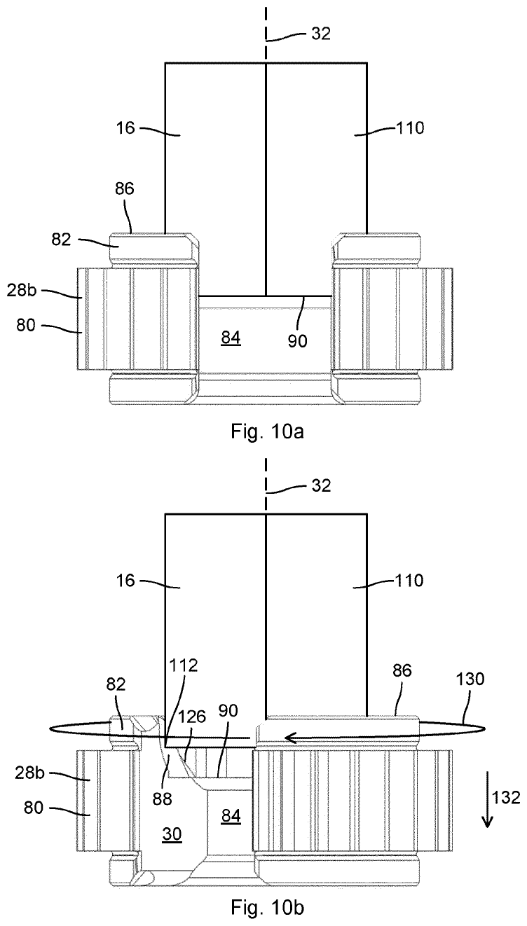

FIG. 9a schematically represents a top view of the socket 28b receiving the joint 106, and FIG. 10a schematically represents a side view of the socket 28b and the joint 106. In FIGS. 9a and 10a, the socket 28b is in the same position in relation to the bolt 16 as in FIG. 6b. As shown in FIG. 9a, each engaging surface 88 is aligned with a unique engageable surface 110 of the bolt 16.

FIG. 9b schematically represents a top view of the socket 28b and the joint 106. The socket 28b is rotated in the tightening direction 114 causing the bolt 16 to rotate as shown with arrow 128. As can be gathered, the socket 28b is configured to tighten the bolt 16 in a conventional way by rotation in the tightening direction 114.

FIG. 9c schematically represents a top view of the socket 28b and the joint 106, and FIG. 10b schematically represents a side view of the socket 28b and the joint 106, when the socket 28b is rotated in a releasing direction 130, opposite to the tightening direction 114. This causes the socket 28b to rotate about the socket axis 32 relative to the bolt 16, which remains stationary. The rotation of the socket 28b in the releasing direction 130 causes corners 112 of the bolt 16 (here four corners 112 of the bolt 16) to travel along a respective internal slope 126. This causes the power tool 10 to move axially away from the joint 106 with respect to the socket axis 32, as shown with arrow 132.

Also when the power tool 10 comprises the socket 28b, the checking operation may be performed immediately upon completion of a tightening operation. In this case, the checking operation may alternatively comprise a releasing operation including rotating the socket 28b in the releasing direction 130. In this way, the operator does not have to lift the power tool 10 off the bolt 16. Also in this example, the control system 40 can detect when the socket 28b is not engaged with the joint 106, for example when the torque 66 decreases. The releasing operation does not have to be performed in pulses 116a-116c. When the socket 28b is free from the bolt 16, the rotational speed 120 may be increased until the socket 28b reaches the open position 34.

In case the checking operation comprises applying a torque to the socket 28b in the releasing direction 130, the same software can be used in the power tool 10 for functioning with both the socket 28a and the socket 28b. This torque may be small enough for not loosening the joint 106 in case the socket 28a is used and large enough such that the socket 28b can be separated by the engagement between the internal slopes 126 and the corners 112.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A socket for a power tool, the socket being arranged to rotate about a socket axis and comprising:
a cylindrical section having an end surface, a plurality of engaging surfaces parallel with the socket axis on an internal side of the cylindrical section;
an inner section positioned radially inside the cylindrical section with respect to the socket axis and having a stopping surface offset from the end surface such that the engaging surfaces are positioned between the stopping surface and the end surface; and
a socket opening extending radially with respect to the socket axis through the cylindrical section and the inner section,
wherein the cylindrical section comprises at least one internal slope on the internal side of the cylindrical section extending away from the stopping surface.

2. The socket according to claim 1, wherein the at least one internal slope comprises a plurality of internal slopes.

3. The socket according to claim 2, wherein each internal slope of the plurality of internal slopes is straight.

4. The socket according to claim 2, wherein each internal slope of the plurality of internal slopes extends from the stopping surface to the end surface.

5. The socket according to claim 1, wherein the cylindrical section comprises a circular drive profile concentric with the socket axis on an external side of the cylindrical section for being drivingly engaged by a wheel.

6. A method of controlling a power tool for tightening a joint, the power tool comprising a base element having a base opening, a socket according to claim 1, a motor arranged to drive the socket, and a control system configured to control the motor, where the socket is rotatable about the socket axis from an open position where the socket opening is aligned with the base opening, the method comprising:
commanding, by the control system, performance of a tightening operation by the socket for tightening the joint; and
commanding, by the control system, performance of a releasing operation by the socket, after performing the tightening operation.

7. A control system for controlling a power tool for tightening a joint, the power tool comprising a base element having a base opening, a socket according to claim 1, a motor arranged to drive the socket, and a control system configured to control the motor, where the socket is rotatable about the socket axis from an open position where the socket opening is aligned with the base opening, the control system comprising at least one data processing device and at least one memory having at least one computer program stored thereon, the at least one computer program comprising program code which, when executed by the at least one data processing device, causes the at least one data processing device to:
command performance of a tightening operation by the socket for tightening the joint; and
command performance of a releasing operation by the socket, after performing the tightening operation.

8. A method of controlling a power tool for tightening a joint, the power tool comprising a base element having a base opening, a socket having a socket opening, a motor arranged to drive the socket, and a control system configured to control the motor, where the socket is rotatable about a socket axis from an open position where the socket opening is aligned with the base opening, the method comprising:
commanding, by the control system, performance of a tightening operation by the socket for tightening the joint;
commanding, by the control system, performance of a checking operation by the socket, automatically and immediately after performing the tightening operation;
monitoring, by the control system, a response to the checking operation of at least one parameter associated with the socket;
determining, by the control system, based on the response whether the socket is engaged with the joint; and
commanding, by the control system, positioning of the socket in the open position upon determining that the socket is not engaged with the joint.

9. The method according to claim 8, wherein the power tool comprises a socket comprising:
a cylindrical section having an end surface, a plurality of engaging surfaces parallel with the socket axis on an internal side of the cylindrical section;
an inner section positioned radially inside the cylindrical section with respect to the socket axis and having a stopping surface offset from the end surface such that the engaging surfaces are positioned between the stopping surface and the end surface; and
a socket opening extending radially with respect to the socket axis through the cylindrical section and the inner section,
wherein the cylindrical section comprises at least one internal slope on the internal side of the cylindrical section extending away from the stopping surface.

10. The method according to claim 9, wherein the checking operation comprises a releasing operation.

11. The method according to claim 8, wherein the checking operation comprises controlling the socket based on a rotational position, a rotational speed, a rotational acceleration, a torque and/or a current.

12. The method according to claim 8, wherein the checking operation comprises controlling the socket based on a torque that is smaller than a maximum torque during the tightening operation.

13. The method according to claim 8, wherein the checking operation comprises controlling the socket based on a current that is smaller than a maximum current during the tightening operation.

14. The method according to claim 8, wherein the socket is commanded to perform the checking operation in pulses.

15. The method according to claim 14, wherein the socket is controlled based on a relatively large torque during the pulses and based on one of a relatively small, zero or negative torque between the pulses.

16. The method according to claim 14, wherein the socket is controlled based on a relatively large current during the pulses and based on one of a relatively small, zero or negative current between the pulses.

17. The method according to claim 14, wherein the pulses have a frequency of at least 5 Hz.

18. The method according to claim 8, wherein the at least one parameter comprises a rotational position, a rotational speed, a rotational acceleration, a torque and/or a current.

19. The method according to claim 8, further comprising determining whether the tightening operation was successful, and commanding performance of the checking operation upon determining that the tightening operation was successful.

20. The method according to claim 8, wherein the power tool comprises an actuating element for being actuated by a human, and wherein the method comprises commanding performance of the tightening operation and the checking operation regardless of whether the actuating element is actuated.

21. A control system for controlling a power tool for tightening a joint, the power tool comprising a base element having a base opening, a socket having a socket opening, a motor arranged to drive the socket, and a control system configured to control the motor, where the socket is rotatable about a socket axis from an open position where the socket opening is aligned with the base opening, the control system comprising at least one data processing device and at least one memory having at least one computer program stored thereon, the at least one computer program comprising program code which, when executed by the at least one data processing device, causes the at least one data processing device to:
command performance of a tightening operation by the socket;
command performance of a checking operation by the socket, automatically and immediately after performing the tightening operation;
monitor a response to the checking operation of at least one parameter associated with the socket;
determine based on the response whether the socket can rotate freely; and
command positioning of the socket in the open position upon determining that the socket can rotate freely.

22. The control system according to claim 21, wherein the power tool comprises a socket comprising:
a cylindrical section having an end surface, a plurality of engaging surfaces parallel with the socket axis on an internal side of the cylindrical section;
an inner section positioned radially inside the cylindrical section with respect to the socket axis and having a stopping surface offset from the end surface such that the engaging surfaces are positioned between the stopping surface and the end surface; and
a socket opening extending radially with respect to the socket axis through the cylindrical section and the inner section,
wherein the cylindrical section comprises at least one internal slope on the internal side of the cylindrical section extending away from the stopping surface.

23. A power tool for tightening a joint comprising:
a base element having a base opening;
a socket arranged to rotate about a socket axis and comprising:
a cylindrical section having an end surface, a plurality of engaging surfaces parallel with the socket axis on an internal side of the cylindrical section;
an inner section positioned radially inside the cylindrical section with respect to the socket axis and having a stopping surface offset from the end surface such that the engaging surfaces are positioned between the stopping surface and the end surface; and
a socket opening extending radially with respect to the socket axis through the cylindrical section and the inner section, wherein the socket is rotatable about the socket axis from an open position where the socket opening is aligned with the base opening,
wherein the cylindrical section comprises at least one internal slope on the internal side of the cylindrical section extending away from the stopping surface;
a motor arranged to drive the socket; and
a control system configured to control the motor, the control system comprising at least one data processing device and at least one memory having at least one computer program stored thereon, the at least one computer program comprising program code which, when executed by the at least one data processing device, causes the at least one data processing device to:
command performance of a tightening operation by the socket for tightening the joint; and
command performance of a releasing operation by the socket, after performing the tightening operation.

24. The power tool according to claim 23, wherein the at least one computer program comprising program code which, when executed by the at least one data processing device, further causes the at least one data processing device to:
command performance of a checking operation by the socket, automatically and immediately after performing the tightening operation;
monitor a response to the checking operation of at least one parameter associated with the socket;
determine based on the response whether the socket can rotate freely; and
command positioning of the socket in the open position upon determining that the socket can rotate freely.
